(19) United States
(12) Patent Application Publication
(10) Pub. No.: US 2008/0127577 A1
(43) Pub. Date: Jun. 5, 2008

(54) Connecting device and method for connecting two wall elements of an elevator cage

(76) Inventors: Pius Elmiger, Lucerne (CH); De Zhi Zheng, Shanghai (CN); Steven Bian, Shanghai (CN)

Correspondence Address: Klaus P. Stoffel;Wolff & Samson, One Boland Drive, West Orange, NJ, 07052, US

(21) Appl. No.: 11/998,704

(22) Filed: Nov. 30, 2007

(30) Foreign Application Priority Data
Dec. 4, 2006 (EP) 06125288.8

(51) Int. Cl. B66B 11/02; E04B 2/00; E04G 17/00; E04G 21/14; F16B 5/06

(52) U.S. Cl. 52/30; 403/292; 52/470; 52/745.21

(57) ABSTRACT

A connecting element for connecting a first wall element and a second wall element, which is adjacent thereto, but spaced therefrom by a gap, of an elevator cage, includes a first plate element with a first edge region for resting on a first wall surface of the first wall element, a second edge region for resting on a second wall surface of the second wall element and a first middle region which connects these two edge regions and covers the gap. A second plate element is provided and has a third edge region for resting on a third wall surface of the first wall element, a fourth edge region for resting on a fourth wall surface of the second wall element and a second middle region connecting these two edge regions and covering the gap. The first plate element is connected with the second plate element to be movable relative thereto in a first direction. The connecting device includes, in addition, tightening elements for tightening the first and second middle regions relative to one another in the first direction so that the first wall element is clamped between the first and third edge regions and the second wall element is clamped between the second and fourth edge regions.

### BACKGROUND OF THE INVENTION

The present invention relates to a connecting device for connecting two wall elements of an elevator cage and to the method carried out for the connecting.

It is known to assemble a wall of an elevator cage from two or more wall elements in that each two adjacent wall elements are connected together. This makes it possible, for example, to introduce the individual wall elements through a shaft door and to assemble them in the elevator shaft to form a larger cage wall. Advantageously, in reverse manner a cage wall which is larger than the shaft door can also be removed again element by element from the elevator shaft.

For this purpose the individual wall elements are brought in succession into their final position and fastened there to, for example, frame corner profile members, the elevator ceiling and/or the elevator floor in that they are, for example, screw-connected there or inserted into rails. In order in that case to handle the individual wall elements, in particular to be able to get around the edges thereof, there is usually left between two adjacent wall elements in the final position a gap by which the two wall elements are spaced from one another. This gap can, for example, extend substantially in vertical direction and then makes it possible to get around vertical edge regions of the wall elements in order to arrange these adjacent to one another or remove them again from this position. Equally, the gap can also extend, for example, in substantially horizontal direction and then allows arrangement of the wall elements one above the other.

Advantageously the gap is subsequently covered by an inner lining, for example a mirror or the like. Nevertheless, a gap prejudices the stiffness of the interrupted cage wall as well as its thermal and acoustic insulation relative to the elevator shaft.

It is therefore known from, for example, JP 03-192088 A to subsequently close the gap between wall elements, which are already screw-connected together by way of cross members, by an intermediate member. The stiffness of the cage wall is in that case substantially imparted by the additional cross members. The illustrated method is not, however, suitable for connecting wall elements of composite plates—for example composite plates with a honeycomb core or composite plates with a foamed material core—since these usually do not have any connecting elements for attachment of the cross members.

WO 2005/031085 A1 discloses a connecting device for connecting plate-shaped wall elements, without reference to an elevator cage. The connecting device consists of a flange for support on a side of two adjacent wall elements, a counter-flange for support on an opposite side of the two wall elements and a web which connects flange and counter-flange together. The counter-flange has to be deformed for introduction into the gap and for this purpose is of resilient construction so that after introduction it snaps back into its original shape. The flange is similarly constructed to be resilient and slightly dome-shaped so that on introduction it flattens at one side and draws the counter-flange back against the opposite side of the wall elements. Since the spacing between the flange and the counter-flange over the web which connects them—the length of the which according to the teaching of WO 2005/031085 A1 is to correspond with the wall elements of the wall elements to be connected—is substantially invariable and the two flanges in the mounted state engage behind the two sides of the wall elements and completely cover the intermediate gap, the counter-flange cannot, without deformation, be led through the gap, because its length covering the gap prevents introduction perpendicularly through the gap. In addition, even in the case of an oblique introduction, one edge of the flange and the opposite edge of the counter-flange block introduction of the counter-flange. Thus, the afore-described resilient deformation of the flange and counter-flange in the connecting device known from WO 2005/031085 A1 is necessarily absolutely essential for mounting.

Such a connecting device, in which the counter-flange is strongly deformed for the introduction and accordingly has to be constructed to be soft and in which the flange and the counter-flange are drawn against the sides of the wall elements only by the tension force resulting from the resilient deformation of the flange, connects the two elements relatively softly together. In particular, the two wall elements can under resilient deformation of the soft counter-flange displace relative to one another in a direction perpendicular to the gap. In addition, in the plane of the wall elements in which these are connected together by way of the friction-coupling contact between the flanges and the sides of the wall elements the connecting device can transmit only small forces from the normal force which results from resilient deformation of the flange and limits the friction couple. Overall, a wall consisting of wall elements connected together by such a connecting device therefore has only a low stiffness.

### SUMMARY OF THE INVENTION

The object of the present invention is to provide a connecting device for connecting two wall elements of an elevator cage by which plate-shaped wall elements can be connected together without integrated connecting elements and which has a high degree of stiffness and can be mounted from the inner side of the elevator cage.

A connecting device according to the invention serves for connecting a first, in particular plate-shaped, wall element and a second, in particular plate-shaped wall element, which is adjacent thereto and spaced by a gap from the first, of an elevator cage. In that case the gap can extend over the entire mutually facing end faces of the two wall elements. This allows construction of simple end faces and connection on a largest possible length. The gap can equally also extend only over part regions which allow reaching behind the wall elements by a hand or mounting tool, while the wall elements contact in the remaining regions by their end faces. In both cases the connecting device advantageously extends over the entire length of the gap, which ensures a maximum stiffness and advantageously thermally and acoustically insulates the elevator cage relative to the elevator shaft. The gap widths can, for example, lie in the range of 50 to 100 millimeters so as to make it possible to reach behind the wall elements by a hand.

A connecting device according to the present invention comprises a first plate element with a first edge region for resting on a first wall surface of the first wall element, a second edge region for resting on a second wall surface of the second wall element and a first middle region connecting these two edge regions and covering the gap as well as a second plate element with a third edge region for resting on a third wall surface of the first wall element, a fourth edge region for resting on a fourth wall surface of the second wall element and a second middle region connecting these two edge regions and similarly covering the gap. In the mounted state the first and third edge regions as well as the second and fourth edge regions thus form receiving grooves for reception of mutually facing edge regions of the first and second wall elements.

The first and second wall surfaces as well as the third and fourth wall surfaces of the first and second wall elements, respectively, are aligned with one another in a preferred construction. Equally, the first and second and/or the third and fourth wall surfaces can be offset and/or inclined relative to one another. Thus, a connecting device according to one embodiment of the present invention can also connect together mutually offset wall elements or wall elements which together form an angle.

According to the invention the first plate element is now connected with the second plate element to be movable relative thereto in a first direction so that the afore-mentioned receiving grooves are variable in their width. In that case the connecting device comprises tightening means for tightening the first and second middle regions relative to one another in the mentioned first direction. Due to the tightening, the first wall element can be clamped in the variable receiving grooves between the first and third edge regions and the second wall element can be clamped between the second and fourth edge regions.

These features enable introduction of the second plate element, which is connected with the first plate element, through the gap in that the two plate elements are initially sufficiently spaced from one another in the first direction. Then the second plate element can, with an appropriate inclined setting, be so introduced into the gap that its edge regions engage behind the wall elements. The first and second middle regions are subsequently tightened by the tightening means relative to one another in the first direction. In this connection the receiving grooves close and then provide friction-locking clamping of the mutually facing edge regions of the two wall elements.

Since a connecting device according to the invention does not require any deformation of the second plate element for introduction into the gap, the connecting device can be constructed to be stronger and stiffer. In particular, at least one of the two plate elements can be constructed to be substantially rigid, i.e. with a high degree of stiffness, parallel to the gap plane and thus substantially increase the stiffness of the cage wall perpendicularly to the gap plane. In addition, the first, second, third and/or fourth edge region of the plate elements can be constructed to be of large area so that large support surfaces between the plate elements and the wall surfaces of the wall elements to be connected are present. The pressure loading of the wall elements per unit of area is thereby reduced and the stiffness of the connection is increased. The plate elements are preferably each of integral construction, for example of steel sheets.

Advantageously, due to the tightening means it is also possible for higher normal forces to be generated between the edge regions of the plate elements and the wall surfaces of the wall elements and thus a higher friction couple to be imparted. In addition, the stiffness of the entire connection can thereby be increased in all directions.

For this purpose, the tightening means in a preferred embodiment comprise one or more screw bolts, preferably constructed as clamping screws, which co-operate with associated internal threads, preferably with threaded nuts, and during screwing tighten the two middle regions of the plate elements relative to one another in the first direction. In that case the clamping screws can engage through through-bores in the two plate elements and be screwed into separate threaded nuts, which are present behind the plate element remote from the screw heads. Equally, the internal threads can also be integrated in the plate element remote from the screw heads in that, for example, an internal thread is formed in the middle region thereof or a threaded sleeve is fixedly connected with the middle region thereof. Conversely, instead of separate clamping screws it is also possible to use screw bolts which are fixedly connected with the middle region of one plate element and protrude towards the middle region of the other plate element and which engage through a through-bore therein and are screwed into an internal thread present in this middle region or into a threaded nut arranged behind this middle region.

The afore-described variants of a screw connection can also be combined with one another. Thus, the two middle regions can have screw bolts which protrude in opposite sense and are fixedly connected with the middle regions and which engage through through-bores in the respective other middle region and are screwed therebehind into a threaded nut. Additionally or alternatively both middle regions can have integrated internal threads or threaded nuts into which separate clamping screws are screwed. Such a combination can make it possible to use identical plate elements, wherein the first is turned relative to the second through 180° so that screw bolts and complementary threaded nuts are aligned with one another. In addition, independently of this combination the first and second plate elements can be of identical construction, which reduces production, stocking and assembly cost.

Through the use of such a screw connection the individual plate elements can be produced in simple manner as semi-finished products and joined together to form the connecting device. The plate elements connected together in such a manner advantageously make possible the introduction of the second plate element into the gap between the two wall elements, so that the second plate element engages behind the two edge regions—which adjoin the gap and are remote from the inner side of an elevator cage—of the wall elements, and subsequently the mutual tightening, which is carried out from the inner side of the elevator cage, of the wall elements between the plate elements.

The tightening means can, additionally or alternatively to the screw connection, comprise one or more resilient spring elements, particularly helical springs, which resiliently connect together or draw towards one another the two plate elements. In a tightening-free position the spring elements then space the plate elements apart in the first direction at a spacing which is less than the wall thickness of the wall elements so that the spring elements in the mounted state tighten the two plate elements relative to one another and in that case clamp the wall elements in the receiving grooves by a friction couple. In addition, the spring elements produce the afore-described initially large spacing of the plate elements from one another in such a manner that the second plate element can be introduced through the gap.

That direction which extends substantially perpendicularly to the gap plane is termed first direction in the following. The plane which extends between the two mutually opposite end faces of the adjacent wall elements is then termed gap plane.

In a preferred embodiment of the connecting device, the two middle regions of the plate elements contact one another in the mutually tightened state. The stiffness of the connecting device thereby increases, since the two plate elements are supported in shape-locking manner relative to one another. Particularly in this embodiment it can be advantageous to so construct the plate elements that the first and third edge regions and/or the second and fourth edge regions have a spacing from one another which is less than the wall thickness of the wall element to be clamped when the middle regions contact one another and no wall element is located between the edge regions. It is thereby ensured that in the mounted state the wall elements are clamped in the receiving groove formed by the edge regions of the two plate elements. The plate elements are then conceived in such a manner than on tightening the plate elements with the wall elements on one hand no plastic deformations of the plate elements result and on the other hand sufficient, but not impermissibly high, clamping forces result. Compensation for production and mounting tolerances can be provided thanks to the resilience of the plate elements.

The first middle region of the first plate element can have at least one outer inclined surface which adjoins an edge region of this plate element, wherein this inclined surface is so inclined that it leads away from the second plate element in a direction towards the adjoining edge region. If such a connecting device is tightened after introduction into the gap, then initially an edge of the corresponding wall element comes into contact with the outer inclined surface. Since this is inclined relative to the first direction in which the plate elements have to move towards one another when being tightened the connecting device is, during tightening, moved away by the outer inclined surface sliding on the edge of the wall element, and thus the connecting device, from this edge until the edge region of the first plate element rests on a wall surface of the wall element.

In an advantageous embodiment the first middle region is connected not only with the first edge region, but also the second edge region by way of a respective outer inclined surface. In this case the connecting device during tightening pushes the two wall elements apart by the outer inclined surfaces, which slide on the edges of the two wall elements and are inclined in opposite sense, and in that case spaces the wall elements at an intended gap width. Moreover, the outer inclined surfaces produce a correct positioning of the connecting device in the gap, whereby an advantageous distribution of the normal forces exerted by the tightening means on the wall elements and thus the intended friction couple are guaranteed.

Further outer inclined surfaces formed in the second middle region can also achieve the same effects. Additionally or alternatively, therefore, the second middle region can also be connected with the third and/or fourth edge region of the second plate element by way of further outer inclined surfaces adjoining the third or fourth edge region of the second plate element. These inclined surfaces are inclined so that they lead away from the first plate element in a direction towards the respectively adjoining edge region.

In a further preferred embodiment, which can in particular be combined with the afore-described embodiment with at least one outer inclined surface, the first middle region has two middle inclined surfaces which are respectively inclined in opposite sense with respect to the first direction defined in the foregoing, while the second middle region similarly has two middle inclined surfaces which have the same inclinations in opposite sense as the middle inclined surfaces of the first middle region and are arranged so that in the tightened state of the two plate elements the middle inclined surfaces of the first middle region rest on the middle inclined surfaces of the second middle region. Through the co-operation of the middle inclined surfaces during tightening the two plate elements are positioned relative to one another transversely to the longitudinal direction of the gap present between the wall elements and are non-displaceably fixed in the direction.

The inclined surfaces are advantageously produced by bending over the middle regions. These bendings in the longitudinal direction of the gap, i.e. in the longitudinal direction of the connecting device, in addition increase the stiffness of the connecting device in the longitudinal direction. For this purpose at least one of the two plate elements can additionally or alternatively have further bendings and/or reinforcings, particularly ribbings, material thickenings or the like. Such bendings and/or reinforcings can also be formed in a transverse direction of the connecting device, i.e. between the two wall elements.

In a preferred embodiment a seal is arranged in the edge region, which faces the gap, of the first and/or second wall element and seals this edge region of the wall element relative to the first and/or second middle region of the plate element. A thermal, acoustic and/or climatic insulation of the elevator cage relative to the elevator shaft can thereby be improved. The seal can for this purpose be arranged in, for example, receiving grooves in the end faces of the wall elements and have a resilient flange which in the mounted state presses against a middle region, particularly against an outer inclined surface, and thus seals the wall elements relative to the corresponding plate element.

For connecting the first and second wall elements initially, a receiving groove formed by the first and third edge regions or by the second and fourth edge regions of the first and second plate elements is pushed over an edge region of the first wall element. For this purpose the plate elements sufficiently spaced apart by way of the tightening means are set at an inclination to the gap plane and subsequently the second plate element is pushed through the gap so that its third and fourth edge regions engage behind the third and fourth wall surfaces of the first and second wall elements, respectively. The first and second middle regions are now tightened relative to one another in the first direction by the tightening means in that, for example, the clamping screws are tightened or the nuts are screwed onto stationary screw bolts. The receiving grooves thereby close and the first wall element is clamped between the first and third edge regions and the second wall element between the second and fourth edge regions.

If the connecting device in a preferred embodiment has at least one of the afore-described outer inclined surfaces then, insofar as the connecting device does not already coincidentally lie in the final mounting position and the wall elements do not already have their intended spacing from one another, at least one edge of a wall element comes into contact with at least one outer inclined surface which is inclined relative to the first direction. On mutual approach of the two plate elements in the first direction this edge slides, caused by the tightening means acting in this direction, on the said outer inclined surface, whereby the connecting device is automatically positioned in its intended location in the gap, preferably centred, and the two wall elements are spaced apart at the intended gap width.

In this manner the first and second wall elements can be connected together from the inner side of the elevator cage, wherein the second plate element which is initially loosely connected with the first plate element and movable relative thereto in the first direction can be readily manipulated by way of the first plate element and in addition positioned correctly in location by way of the inclined surfaces themselves. This enables a quick, simple and economic assembly of the cage wall, wherein the connecting device significantly increases the stiffness thereof.

Other features and advantages of the present invention will become apparent from the following description of the invention.

### BRIEF DESCRIPTION OF THE DRAWINGS

FIG. 1 shows a connecting device according to a first embodiment of the present invention in a tightened state between two wall elements;

FIG. 2 shows a state of the connecting device according to FIG. 1 during connecting of the two wall elements; and

FIG. 3 shows an embodiment of the connecting device with helical springs for resilient connecting of the two plate elements.

### DETAILED DESCRIPTION OF THE INVENTION

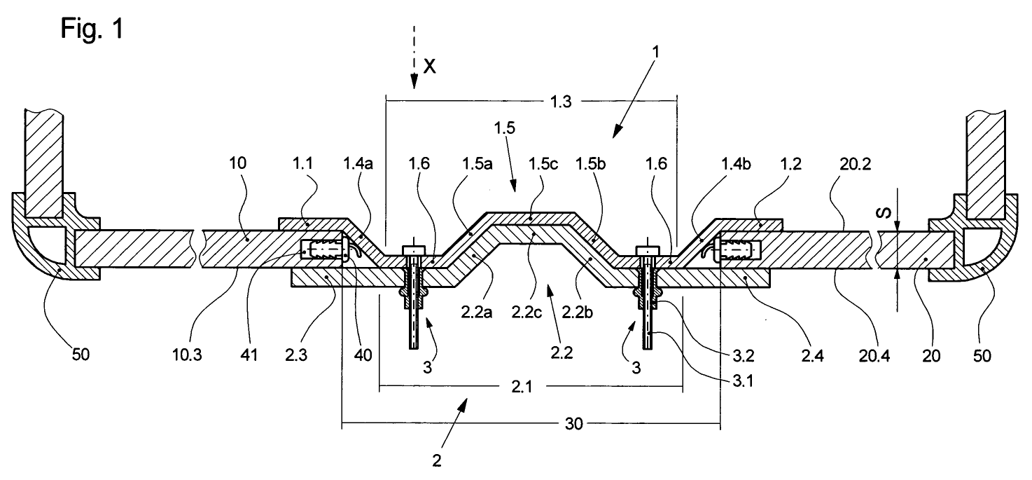

FIG. 1 shows, in a horizontal section, a connecting device according to a first embodiment of the present invention with a first plate element 1 and a second plate element 2, which device is arranged in a gap 30 between a first wall element 10 and a second wall element 20 of a rear wall of an elevator cage. The first and second wall elements 10, 20 are aligned with one another in the illustrated embodiment.

The second plate element 2, which in the illustrated embodiment faces an outer side of the cage, lies over an area by a third edge region 2.3 on a third wall surface 10.3 of the first wall element 10 and by a fourth edge region 2.4 on a fourth wall surface 20.4 of the second wall element 20. The two edge regions 2.3, 2.4 are connected together by a second middle region 2.1, so that the second plate element 2 covers the entire gap 30 as well as the adjoining edge regions of the first and second wall elements 10, 20.

The second middle region 2.1 of the second plate element 2 is bent over approximately in its middle towards the first plate element 1 so that it has two middle inclined surfaces 2.2a, 2.2b which are set at an inclination in opposite sense and between which an intermediate region 2.2c approximately parallel to the third and fourth edge regions 2.3, 2.4 extends. This intermediate region 2.2c forms, together with the middle inclined surfaces 2.2a, 2.2b, a projection 2.2 which protrudes out of the plane of the third and fourth edge regions 2.3, 2.4 approximately in the middle of the second middle region 2.1 towards the first plate element 1.

Apart from a positioning function explained in more detail in the following, the described projection 2.2 stiffens the second plate element in its longitudinal axis parallel to the longitudinal axis of the gap, i.e. in particular against bending about an axis horizontal in the drawing plane of FIG. 1.

In the mounted state illustrated in FIG. 1 the first plate element 1 lies by a first edge region 1.1 over an area on a first wall surface 10.1 of the first wall element 10 and by a second edge region 1.2 on a second wall surface 20.2 of the second wall element 20. The two edge regions 1.1, 1.2 are connected together by a middle region 1.3 so that the first plate element 1 covers the entire gap 30 as well as adjoining edge regions of the first and second wall elements 10, 20.

The first middle region 1.3 of the first plate element 1 has two outer inclined surfaces 1.4a, 1.4b, of which one inclined surface 1.4a adjoins the first edge region 1.1 of the plate element 1 and is inclined relative thereto, while the other inclined surface 1.4b adjoins the second edge region 1.2 and is inclined in opposite sense. The two outer inclined surfaces 1.4a, 1.4b respectively extend to a part, which is aligned with the third and fourth edge regions 2.3, 2.4, of the second middle region 2.1, where they go over into screw-connection regions 1.6, which are parallel to the first and second edge regions 1.1, 1.2, of the first middle region 1.3.

The first middle region 1.3 is bent in such a manner that it has two middle inclined surfaces 1.5a, 1.5b which are set at an inclination in opposite sense and between which an intermediate region 1.5c approximately parallel to the first and second edge regions extends. This intermediate region 1.5c forms together with the two middle inclined surfaces 1.5a, 1.5b a groove 1.5 in the longitudinal direction of the first plate element 1 in which the projection 2.2 of the second middle region 2.1 can engage in a shape-locking manner.

The bendings, which produce the middle inclined surfaces 1.5a, 1.5b, of the first middle region 1.3 stiffen the first plate element 1 in its vertical longitudinal axis, i.e. in particular against bending about an axis horizontal in the drawing plane of FIG. 1.

The two plate elements 1, 2 are produced from single steel sheets, wherein their form is produced by multiple bending.

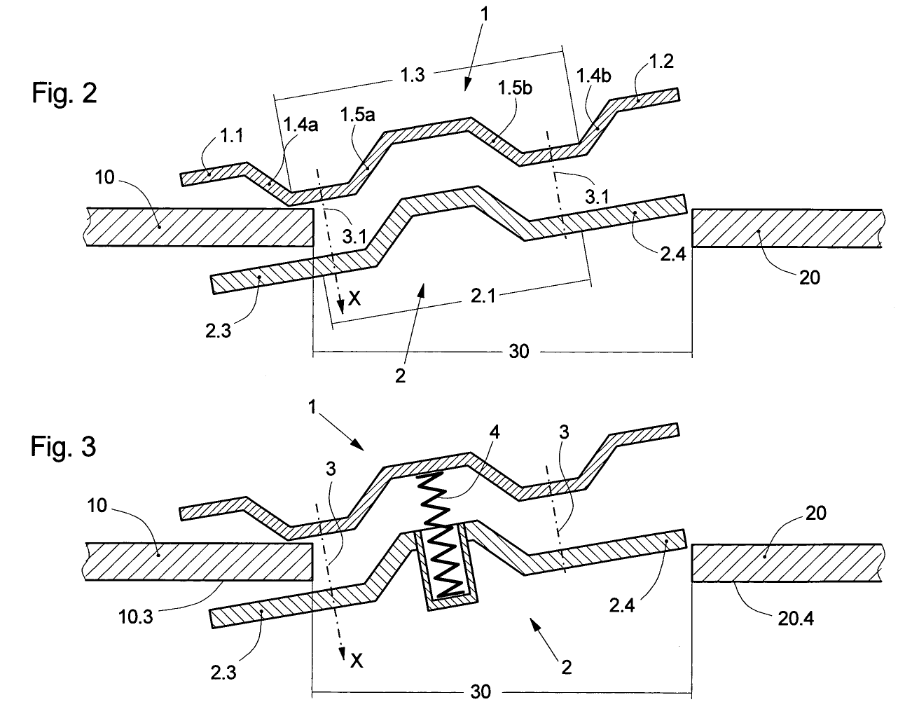

The connecting device illustrated in FIGS. 1 and 2 comprises tightening means 3 in the form of clamping screws 3.1, which engage through through-bores in the screw-connection regions 1.6 of the first plate element 1 from the cage inner side and are screwed into threaded sleeves 3.2 fixed in corresponding bores in the second plate element 2, for example riveted or pressed in place. Instead of the separate threaded sleeves internal threads can also be directly formed in the second plate element 2, for example cut in or shaped without cutting.

In a mounted state shown in FIG. 2 the first plate element 1 is spaced relatively far from the second plate element 2 along a first direction X predetermined by the axes of the clamping screws 3.1 so that with appropriate inclined setting of the second plate element 2 it can be so introduced into the gap 30 that its edge regions 2.3, 2.4 engage behind the wall surfaces 10.3 and 20.4 of the two wall elements 10, 20.

By screwing the clamping screws 3.1 into the threaded sleeves 3.2, the first middle region 1.3 of the first plate element 1 is drawn in the first direction X against the second middle region 2.1 of the second plate element 2 and tightened against this, as is illustrated in FIG. 1. In that case the projection 2.2 in the second middle region 2.1 engages in a shape-locking manner in the groove 1.5 in the first middle region 1.3, wherein in each instance the middle inclined surfaces 1.5a and 2.2a as well as the middle inclined surfaces 1.5b and 2.2b contact one another and automatically position the first plate element 1 on the second plate element 2. This makes it possible to form the through-bores, which are passed through by the clamping screws, in the first plate element to be somewhat larger than the screw diameter and thus provide compensation for tolerances between through-bores and threaded sleeves 3.2 which are not in exact alignment. In addition, the projection 2.2 engaging in the groove 1.5 fixes the first and second plate elements 1, 2 in shape-locking manner in a plane parallel to the edge regions and in this way stabilizes the entire connecting device.

The first plate element 1 is so dimensioned that the spacing between the two transitions from its outer inclined surfaces 1.4a, 1.4b to its edge regions 1.1, 1.2 substantially correspond with the width of the gap 30. The first plate element 1 and the second plate element 2 connected therewith by way of the clamping means 3 thus automatically center in the gap 30 in that the outer inclined surfaces 1.4a, 1.4b slide on the mutually facing edges of the wall elements 10, 20.

If the second plate element 2 is tightened against the first plate element 1 then the spacing between the outer inclined surfaces 1.4a, 1.4b and the third and fourth edge regions 2.3, 2.4 of the second plate element 2 reduces in the first direction X. The edge regions, which bear against the outer inclined surfaces 1.4a, 1.4b and the third and fourth edge regions 2.3, 2.4, of the wall elements are thereby moved away outwardly. The connecting device during tightening thus spaces the two wall elements 10, 20 at an intended gap width 30.

FIG. 3 schematically shows an embodiment of the connecting device in which the two plate elements 1, 2 are connected together by means of spring elements, preferably by means of at least one helical spring 4. The connecting device is illustrated in a mounted position in which the plate elements 1, 2 are spaced from one another in the direction X to such an extent that the second plate element 2 can be introduced into the gap 30 and engage by its edge regions 2.3, 2.4 behind the wall surfaces 10.3, 20.4, which are remote from the inner side of the elevator cage and adjoin the gap 30, of the two wall elements 10, 20. The at least one helical spring 4 is so designed that on the one hand it can be stretched to such an extent that the mentioned spacing of the plate elements during mounting of the connecting device is possible by hand and that on the other hand it can draw the two plate elements towards one another to such an extent that these rest on one another and in that case at least lightly clamp the wall elements to be connected. The helical springs 4 preferably serve as aids to facilitate mounting, wherein the two plate elements 1, 2 after application of the connection device are mutually tightened together with the wall elements by the afore-described clamping means 3. However, it is also possible to design the helical springs 4 so that they supply, without additional tightening means, the clamping force required in order to connect the wall elements 10, 20 together with sufficient stability.

As illustrated in FIG. 1, a respective resilient longitudinal seal 40 is received in the mutually facing end faces of the first and second wall elements 10, 20 in a vertical groove 41, which seal seals the wall elements in the tightened state against the outer inclined surfaces 1.4a, 1.4b and thus insulates the elevator cage thermally, acoustically and climatically relative to the elevator shaft.

In order to connect together the wall elements 10, 20 already fixed in stationary frame corner profile members 50 of the elevator cage (cf. FIG. 1), initially the two plate elements 1, 2 are, as schematically illustrated in FIG. 2, sufficiently spaced from one another in the first direction X. For this purpose the clamping screws 3.1 are unscrewed to an appropriate extent from the threaded sleeves 3.2. With an inclined setting of the connecting device the second plate element 2 can then be introduced from the cage inner side (lying at the top in FIGS. 1 and 2) through the gap 30 so that the third and fourth edge regions 2.3, 2.4 engage behind the third and fourth wall surfaces 10.3, 20.4 respectively. In that case the second plate element 2, which is connected with the first plate element 1 by way of the screws 3.1, can be readily manipulated by this from the cage inner side.

The clamping screws 3.1 are subsequently screwed into the threaded sleeves 3.2, whereby the first plate element 1 is drawn against the second plate element 2. In this respect the third and fourth edge regions 2.3, 2.4 bear against the third and fourth wall surfaces 10.3, 20.4 respectively, the two plate elements are mutually aligned or positioned by the projection 2.2, which engages in the groove 1.5 of the first plate element 1, of the second plate element 2, and the edges, which face the gap, of the wall elements 10, 20 to be connected come into contact with the outer inclined surfaces 1.4a, 1.4b.

On further screwing-in of the clamping screws 3.1 the spacing of the outer inclined surfaces 1.4a, 1.4b from the third and fourth edge regions 2.3, 2.4, respectively, reduces. In that case the edges of the wall elements slide along the outer inclined surfaces 1.4a, 1.4b, whereby the connecting device is automatically centered in the gap 30. If the mutually parallel screw-connection regions 1.6, which adjoin the outer inclined surfaces 1.4a, 1.4b of the first plate element 1, finally come into contact with the third and fourth edge regions 2.3, 2.4 of the second plate element 2 the connecting device is tightened. In this state the mutually facing edge regions of the first and second wall elements 10, 20 are clamped in friction-locking manner in receiving grooves formed between the first and third edge regions 1.1, 2.3 and between the second and fourth edge regions 1.2, 2.4 of the plate elements, wherein a sufficient normal force for realisation of a high friction couple can be applied by the clamping screws 3.1. The opening width of the receiving grooves is so dimensioned that in the tightened state it is the same as or slightly smaller than the wall thickness (S) of the wall element to be clamped therein. On tightening of the two plate elements 10, 20 by the intended screw torque the edge regions 1.1, 1.2, 2.3, 2.4 of the plate elements 1, 2 are then resiliently spread apart by the wall elements 10, 20 so that they clamp and thereby fix in friction-locking manner the wall elements.

When the plate elements of the connecting device have reached their end position the mutually facing edges, which are the cage inner side, of the first and second wall elements 10, 20 are supported on the outer inclined surfaces 1.4a, 1.4b, whereby the connecting device is positioned in shape-locking manner in the gap plane and the wall elements are spaced at the intended gap width. The two plate elements are also fixed in shape-locking manner in their mutual position by the projection 2.2 engaging in the groove 1.5.

As described in the foregoing, the connecting device supports the two wall elements in a shape-locking manner relative to one another in the gap plane and in that case spaces them at the intended gap width. In addition, the receiving grooves clamp the edge regions of the wall elements and thus fix these in the gap plane. A high level of normal force which produces a correspondingly high friction couple can in that case be applied by the clamping means 3. Stiff plate elements 1, 2, which are produced from, for example, bent steel sheets, promote a high stiffness of a cage wall and also the mutual fixing of the wall elements by friction couple.

Since the plate elements 1, 2 movable relative to one another can be sufficiently spaced apart, for introduction into in the gap 30, before they are tightened together with the help of the tightening means 3 it is possible to provide large-area first to fourth edge regions 1.1, 1.2, 2.3, 2.4, which make possible correspondingly large clamping forces at the wall elements with relatively small permissible pressure loading. Moreover, such large-area edge regions also promote transmission of high bending moments, which lead to a corresponding increase in the overall stiffness of the cage wall.

The bendings serve not only for shape-locking spacing and automatic centering, but additionally stiffen the connecting device in its longitudinal direction.

Overall, a very stiff connection between the two wall elements thus results, which in addition can be easily and quickly mounted from the inner side of the elevator cage and also demounted again.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A connecting device for connecting a first wall element with a second wall element, which is spaced from the first wall element by a gap, of an elevator cage, comprising:
a first plate element having a first edge region for resting on a first wall surface of the first wall element, a second edge region for resting on a second wall surface of the second wall element and a first middle region connecting the first and second edge regions and covering the gap;
a second plate element with a third edge region for resting on a third wall surface of the first wall element, a fourth edge region for resting on a fourth wall surface of the second wall element, and a second middle region connecting the third and fourth edge regions and covering the gap, wherein the first plate element is connected with the second plate element so as to be displaceable relative thereto in a first direction; and
tightening elements for tightening the first and the second middle regions relative to one another in the first direction so that in a tightened state the first wall element can be clamped between the first and third edge regions and the second wall element can be clamped between the second and fourth edge regions.

2. The connecting device according to claim 1, wherein the first and second middle regions contact one another in the tightened state.

3. The connecting device according to claim 1, wherein the first middle region has at least one outer inclined surface that adjoins one of the first and second edge regions and is inclined relative thereto towards the second plate element.

4. The connecting device according to claim 2, wherein the first middle region has at least one inner inclined surface which is inclined relative to the first direction, and the second middle region has at least one inner inclined surface with the same inclination as the at least one inner inclined surface of the first middle region, wherein in the tightened state the at least one inner inclined surface of the first middle region rests on the at least one inner inclined surface of the second middle region.

5. The connecting device according to claim 1, wherein the tightening elements include at least one screw bolt.

6. The connecting device according to claim 5, wherein the screw bolt is a clamping screw.

7. The connecting device according to claim 5, wherein a threaded nut is associated with each screw bolt, wherein the screw bolt or the associated threaded nut is fixedly connected with the first or second plate element.

8. The connecting device according to claim 7, wherein the threaded nut is integrally connected with the second plate element.

9. The connecting device according to claim 1, wherein the tightening elements include at least one resilient spring element.

10. The connecting device according to claim 9, wherein the spring element is a helical spring.

11. The connecting device according to claim 1, wherein in the tightened state and without interposed wall elements the first and third edge regions and/or the second and fourth edge regions have a mutual spacing which is smaller than a wall thickness of the wall elements to be clamped.

12. A wall element arrangement of an elevator cage, comprising:
a first wall element;
a second wall element adjacent to the first wall element but spaced therefrom by a gap;
a connecting device for connecting the first wall element with the second wall element, the connecting device including a first plate element having a first edge region for resting on a first wall surface of the first wall element, a second edge region for resting on a second wall surface of the second wall element and a first middle region connecting the first and second edge regions and covering the gap, a second plate element with a third edge region for resting on a third wall surface of the first wall element, a fourth edge region for resting on a fourth wall surface of the second wall element, and a second middle region connecting the third and fourth edge regions and covering the gap, wherein the first plate element is connected with the second plate element so as to be displaceable relative thereto in a first direction, and tightening elements for tightening the first and the second middle regions relative to one another in the first direction so that in a tightened state the first wall element can be clamped between the first and third edge regions and the second wall element can be clamped between the second and fourth edge regions; and
a seal arranged in the edge region of the wall element or those edge regions of the wall elements against the first and/or second middle region.

13. An elevator cage, comprising a connecting device according to claim 1.

14. An elevator cage, comprising a wall element arrangement according to claim 12.

15. A method of connecting a first wall element and a second wall element, which is adjacent to and spaced from the first wall element by a gap, by means of a connecting device including a first plate element having a first edge region for resting on a first wall surface of the first wall element, a second edge region for resting on a second wall surface of the second wall element and a first middle region connecting the first and second edge regions and covering the gap, a second plate element with a third edge region for resting on a third wall surface of the first wall element, a fourth edge region for resting on a fourth wall surface of the second wall element, and a second middle region connecting the third and fourth edge regions and covering the gap, wherein the first plate element is connected with the second plate element so as to be displaceable relative thereto in a first direction, and tightening elements for tightening the first and the second middle regions relative to one another in the first direction so that in a tightened state the first wall element can be clamped between the first and third edge regions and the second wall element can be clamped between the second and fourth edge regions, the method comprising the steps of:
introducing the second plate element, which is sufficiently spaced from the first plate element in the first direction, through the gap;
placing the third and fourth edge regions on the third and fourth wall surfaces, respectively; and
tightening the first and second plate elements relative to one another in the first direction so that the first wall element is clamped between the first and third edge regions and the second wall element is clamped between the second and fourth edge regions.
